(19) United States
(12) Patent Application Publication
(10) Pub. No.: US 2005/0207343 A1
(43) Pub. Date: Sep. 22, 2005

(54) System and method for performing efficient flow control of packet data transmission between a radio network controller and a Node-B in a mobile communication system using a high-speed downlink packet access technique

(75) Inventor: Il Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/078,619

(22) Filed: Mar. 14, 2005

(30) Foreign Application Priority Data
Mar. 17, 2004 (KR) 17986/2004

(51) Int. Cl. H04Q 7/00; H04J 3/14

(52) U.S. Cl. 370/235; 370/278; 370/329

(57) ABSTRACT

A flow control system and method is provided for efficiently transmitting high-speed downlink packet access (HSDPA) packet data between a radio network controller (RNC) and a Node-B in a wideband code division multiple access (WCDMA) system/universal mobile telecommunications system (UMTS).

### PRIORITY

This application claims the benefit under 35 U.S.C. 119(a) of an application entitled “METHOD FOR PERFORMING EFFICIENT FLOW CONTROL OF PACKET DATA TRANSMISSION BETWEEN A RADIO NETWORK CONTROLLER AND ANODE-B IN A MOBILE COMMUNICATION SYSTEM USING A HIGH-SPEED DOWNLINK PACKET ACCESS TECHNIQUE”, filed in the Korean Intellectual Property Office on Mar. 17, 2004 and assigned Ser. No. 2004-17986, the entire contents of which are incorporated herein by reference.

### BACKGROUND OF THE INVENTION

1. Field of the Invention

The present invention relates generally to technology for efficiently transmitting packet data in a wideband code division multiple access (WCDMA)-based mobile communication system. More particularly, the present invention relates to a flow control system and method for efficiently transmitting packet data between a radio network controller (RNC) and a Node-B.

2. Description of the Related Art

Mobile communication systems have developed into high-speed, high-quality wireless data packet communication systems for providing data service and a multimedia service as well as voice service. The 3^{rd} generation (3G) mobile communication system is divided into an asynchronous system (3rd Generation Partnership Project (3GPP)) and a synchronous system (3rd Generation Partnership Project 2 (3GPP2)). According to Release 5, the standardization for a high-speed, high-quality wireless data packet service in the 3G mobile communication system is ongoing. For example, the standardization for high-speed downlink packet access (HSDPA) is ongoing in the 3GPP, and the standardization for 1× Evolution Data and Voice (1×EV-DV) is ongoing in the 3GPP2. The purpose of the standardization is to provide high-quality wireless data packet transfer service at more than 2 Mbps in the 3G mobile communication system. The 4^{th} generation (4G) mobile communication system serves to provide a high-speed, high-quality multimedia service. An enhanced uplink dedicated channel (E-DCH) or uplink for transmitting high-speed, high-quality wireless data packets is discussed in Release 6.

A factor causing a high-speed, high-quality data service to be degraded in the conventional communication system is a wireless channel environment. The environment of a wireless communication channel may be affected by white noise, signal power variations due to fading, shadowing, the Doppler effect due to the mobility or frequent speed variations of a terminal, interference associated with other users and a multipath signal, and so on.

A need exists for advanced technology capable for improving an adaptive capability to channel variations in addition to technology for providing high-speed wireless data packet service in the existing 2G or 3G mobile communication system. A high-speed power control technique adopted in the conventional system may improve the adaptive capability to channel variations. An adaptive modulation & coding scheme (AMCS) and a hybrid automatic repeat request (HARQ) scheme are commonly mentioned in the 3GPP and 3GPP2 for standardizing a high-speed data packet transmission system.

FIG. 1 illustrates the architecture of a conventional asynchronous mobile communication system and protocol for supporting high-speed downlink packet access (HSDPA).

Referring to FIG. 1, the conventional asynchronous mobile communication system includes a core network (CN) (not shown), a plurality of radio network subsystems (RNSs), and a user equipment (UE) 110.

A RNS includes a radio network controller (RNC) and one or more Node-Bs. The RNC is classified as a serving RNC (SRNC), a drift RNC (DRNC), or a controlling RNC (CRNC) according to its function. The SRNC 140 manages information of the UE 110, and is responsible for data communication with the CN. The CRNC 130 controls a Node-B 120 communicating with the UE 110.

In this case, the UE 110 and a universal terrestrial radio access network (UTRAN) are connected through a Uu interface, and the CRNC 130 and the SRNC 140 are connected through an lur interface. The Node-B 120 communicating with the UE 110 and the CRNC 130 are connected through an Iub. The interfaces are defined by the 3GPP, and may be changed.

A higher layer structure and each layer defined by the 3GPP will be described with reference to FIG. 1. Layers of a wideband code division multiple access (WCDMA) system can be classified into a layer for control/signaling and a layer for user data transfer. In data transmission flow, a radio link control (RLC) layer of Layer (L2) (or L2/RLC layer), a medium access control (MAC) layer of L2 (or L2/MAC layer), and a physical layer of Layer 1 (L1) are included.

The physical layer performs channel coding/decoding, modulation/demodulation, and channelization/dechannelization functions, and so on. The physical layer converts data to be transmitted into a radio signal, and converts a received radio signal into data. After transport channel data transmitted to the physical layer is appropriately processed, the processed data is transmitted to the UE or RNC by physical channels. The physical channels include a primary common control physical channel (P-CCPCH) on which a broadcast channel (BCH) is transmitted, a secondary common control physical channel (S-CCPCH) on which a paging channel (PCH) and a forward access channel (FACH) are transmitted, a dedicated physical channel (DPCH) on which a dedicated channel (DCH) is transmitted, a physical downlink shared channel (PDSCH) on which a downlink shared channel (DSCH) is transmitted, a high-speed physical downlink shared channel (HS-PDSCH) on which a high-speed downlink shared channel (HS-DSCH) is transmitted, and a physical random access channel (PRACH) on which a random access channel (RACH) is transmitted. Other physical channels not used to transmit higher layer data or a control signal comprise a pilot channel, a primary synchronization channel, a secondary synchronization channel, a paging indicator channel, an acquisition indicator channel, a physical common packet channel, etc.

The physical layer and the L2/MAC layer are connected through a transport channel. The transport channel defines a technique for processing specific data in the physical layer. The processing technique includes a channel coding technique, an amount of data that can be transmitted in a unit of time, that is, a transport block set size, and so on. The following Table 1 describes types or functions of transport channels.

TABLE 1

| Channel | Function |
|---|---|
| BCH | The BCH mapped to a broadcast control channel (BCCH) |
| | transmits data of the BCCH. |
| PCH | The PCH mapped to a paging control channel (PCCH) transmits |
| | data of the PCCH. |
| RACH | The RACH is used to transmit data from the UE to the network, |
| | and to transmit a network access and control message and short |
| | length data. |
| FACH | The FACH is used to transmit a control message and data from |
| | the network to a specific UE or UEs, and can be mapped to the |
| | BCCH, common traffic channel (CTCH), common control |
| | channel (CCCH), dedicated traffic channel (DTCH) and |
| | dedicated control channel (DCCH). |
| DCH | The DCH mapped to the DTCH and DCCH can transmit data |
| | and a control signal between the network and UE. |
| DSCH | The DSCH mapped to the DTCH and DCCH is a downlink |
| | channel from the network to the UE. |
| HS- | The HS-DSCH mapped to the DTCH and DCCH is a downlink |
| DSCH | channel from the network to the UE, and is a DSCH whose |
| | transmission capability has been improved. |

The L2/MAC layer performs a function for transferring data from the L2/RLC layer using a logical channel to the physical layer through a proper transport channel, and a function for transferring data from the physical layer using the transport channel to the L2/RLC layer through a proper logical channel. The L2/MAC layer inserts additional information into data received through the logical channel or transport channel, or analyzes inserted additional information to perform an appropriate operation according to a result of the analysis. The logical channel is divided into a dedicated channel serving as a channel for a specific UE and a common channel serving as a channel for a plurality of UEs. Moreover, the logical channel is divided into a control channel and a traffic channel according to message type. The following Table 2 describes types or functions of logical channels.

TABLE 2

| Channel | Function |
|---|---|
| BCCH | The BCCH is used for downlink transmission from the UTRAN |
| | to the UE, and is used to transmit UTRAN system control |
| | information. |
| PCCH | The PCCH is used for downlink transmission from the UTRAN |
| | to the UE, and is used to transmit control information to the UE |
| | when a location of a cell to which the UE belongs is not |
| | identified. |
| CCCH | The CCCH is used to transmit control information between the |
| | UE and the network, and is used when a connection channel of |
| | radio resource control (RRC) for the UE is not present. |
| DCCH | The DCCH is used for 1:1 control information transmission |
| | between the UE and the network, and is used when the UE is |
| | connected to a RRC layer. |
| CTCH | The CTCH is used for point-to-multipoint data transmission |
| | between the network and the UEs. |
| DTCH | The DTCH is used for 1:1 data transmission between the |
| | network and the UE. |

The L2/RLC layer receives a control message transmitted for the UE and appropriately processes the received control message while taking into account characteristics of the control message, such that the processed control message is transmitted to the L2/MAC layer using a logical channel. Moreover, the L2/RLC layer processes data in an appropriate wireless resource control form, and transmits the processed data to the L2/MAC layer using the logical channel. The number of RLC entities in the L2/RLC layer depends upon the number of radio links between at least one UE and the RNC.

The Node-B associated with the High Speed Downlink Packet Access (HSDPA) service additionally configures a high-speed medium access control (MAC-hs) layer and a frame protocol (FP) layer.

The MAC-hs layer supports scheduling for UEs according to the HSDPA service and the HARQ technique. The MAC-hs layer determines the priorities of UEs receiving the HSDPA service.

On the other hand, the FP layer controls a frame for generating the HS-DSCH. That is, the HS-DSCH FP layer generates and transmits the HS-DSCH. The MAC-hs layer controls an operation for allocating packet data of the UE supporting the HSDPA service to a specific slot for the generated HS-DSCH. Accordingly, the CRNC 130 connected to the Node-B 120 configures a common/shared MAC (MAC-c/sh) layer and an FP layer. The MAC-c/sh layer stores the HS-DSCH frame.

The SRNC 140 connected to the CRNC 130 through the Iur interface configures a dedicated MAC (MAC-d) layer and an FP layer to support the HSDPA. In the above structure, the HS-DSCH FP layer performs a flow control function for transmitting a HS-DSCH data frame between the Node-B 120 and the CRNC 130, and performs a flow control function for transmitting a HS-DSCH data frame between the CRNC 130 and the SRNC 140. When a MAC-c/sh layer is not present in the CRNC 130, the flow control function for transmitting an HS-DSCH data frame is performed between the FP layer of the Node-B 120 and the HS-DSCH FP layer of the SRNC 140.

FIG. 2 illustrates the architecture of a conventional asynchronous mobile communication system and protocol for supporting HSDPA. In FIG. 2, an SRNC 230 functions as a CRNC. That is, an lur path is absent, and traffic flow for an HSDPA service is controlled between a Node-B 220 and the SRNC 230. The layers illustrated in FIG. 2 are the same as those illustrated in FIG. 1. Therefore, a discussion of the layers will be omitted.

FIG. 3 illustrates a conventional HSDPA flow control process and control messages defined in the 3GPP standard.

The flow control process and the control messages defined in the 3GPP standard will be described with reference to FIG. 3.

In step 310, an RNC 302 sends, to a Node-B 301, a HS-DSCH CAPACITY REQUEST message, which is a request for transport channel capacity required for the HSDPA service when a packet to be transmitted to the Node-B 301 is present. In step 320, the Node-B 301 includes channel resource allocation information in a HS-DSCH CAPACITY ALLOCATION message and sends the HS-DSCH CAPACITY ALLOCATION message in response to the request message 310. In steps 330 and 340, the RNC 302 receiving the response message can transmit, to the Node-B 301, packet data of the HSDPA service according to the channel resource information.

FIG. 4 illustrates a frame format of a conventional HS-DSCH CAPACITY REQUEST message 310.

Referring to FIG. 4, a common channel-priority indicator (CmCH-PI) field 410 indicates a priority of a common channel, and comprises 4 bits. A user buffer size field 420 indicates a size of data associated with a priority of a corresponding user, and comprises 2 bytes.

FIG. 5 illustrates a frame format of a conventional HS-DSCH CAPACITY ALLOCATION message 320.

Referring to FIG. 5, a maximum MAC-d protocol data unit (PDU) length field 510 indicates the maximum acceptable PDU size. An HS-DSCH interval field 530 indicates a time interval during which set packet data may be transmitted. A HS-DSCH credits field 520 indicates the number of PDUs that maybe transmitted during the HS-DSCH interval of field 530. The HS-DSCH repetition period field 540 indicates the number of repeated transmissions of the HS-DSCH during a set time interval. Field 550 comprises a spare extension field, which is an unused field that is not currently assigned for any particular purpose.

Accordingly, the RNC transmits packet data of the number of PDUs set in the HS-DSCH credits field 520 during the interval set in the HS-DSCH interval field 530 according to the PDU size set in the maximum MAC-d PDU length field 510. When a value of the HS-DSCH repetition period field 540 is greater than 1, a transmission operation is repeated by the set number of repeated transmissions.

The HS-DSCH CAPACITY ALLOCATION message can be sent in the following cases.
(1) When the HS-DSCH CAPACITY REQUEST message is received from the RNC, the HS-DSCH CAPACITY ALLOCATION message serving as a response is sent.
(2) When a HS-DSCH data frame is received from the RNC, the HS-DSCH CAPACITY ALLOCATION message is sent such that new HS-DSCH capacity allocation is performed using user buffer size information included in the frame.
(3) When new HS-DSCH capacity allocation is performed according to the resource status of the Node-B, the HS-DSCH CAPACITY ALLOCATION message is sent.

FIG. 6 illustrates a format of a conventional HS-DSCH data frame.

Referring to FIG. 6, the HS-DSCH data frame includes a CmCH-PI field 610 and a user buffer size field 620 as shown in the HS-DSCH CAPACITY REQUEST message illustrated in FIG. 5.

Accordingly, the Node-B can receive a control message of the HS-DSCH CAPACITY REQUEST and the HS-DSCH data frame to perform capacity allocation.

FIG. 7 illustrates an example in which the RNC transmits a conventional HS-DSCH data frame using flow control information of the CAPACITY ALLOCATION message received from the Node-B.

Packet data of the maximum MAC-d PDU length is divided and repeatedly transmitted according to the number of HS-DSCH credits during the interval set in the HS-DSCH interval field. In this case, repeated transmissions vary with a value set in the HS-DSCH repetition period field.

FIG. 8 illustrates a conventional flow control process based on credit information proposed in a wired network.

Referring to FIG. 8, a sender stores information of a buffer size (Buf_Alloc) of a receiver. Whenever a packet is sent, the sender stores information of an accumulated amount of transmission traffic (Tx_Cnt). Meanwhile, the receiver periodically sends, to the sender, information of an accumulated amount of traffic (Fwd_Cnt) forwarded to other entities.

Accordingly, to send data within a range in which overflow does not occur, the sender computes an allowable amount of transmission data (Credit_Balance) to send data within the computed Credit_Balance.

That is, the sender can send data while preventing overflow in the receiver by making use of the control information (Fwd_Cnt) from the receiver.

The flow control process based on the credit information in the wired network illustrated in FIG. 8 cannot be applied to a wideband code division multiple access (WCDMA) system because the above-mentioned flow control process is significantly different from that of a WCDMA mobile communication system.

In the 3GPP standard, the FP layer inside the Node-B determines the number of credits using the user buffer size information associated with the accumulated amount of user data in the RNC and the user buffer size information in the Node-B. Accordingly, the RNC can send, to the Node-B, only packet data of the capacity allocated by the Node-B.

When the RNC sends the packet data to the Node-B through a link interface, an overflow may occur in a link buffer that temporarily stores the packet data, resulting in congestion. That is, because channel capacity based on the HSDPA service is allocated using only an amount of buffering in the Node-B, an overflow in the Node-B can be prevented. However, because a buffer state of the link interface within the RNC is not taken into account, the overflow occurs in the link buffer of the RNC.

In other words, when only the amount of buffering in the Node-B is taken into account in a state in which the overflow in the link interface of the RNC is not taken into account, the RNC may not transmit MAC-d PDUs of the number of HS-DSCH credits during the HS-DSCH interval due to congestion.

When updated capacity allocation is performed in a state in which the Node-B does not identify a congestion state of the RNC link buffer, the congestion state of the RNC link buffer becomes continuously worse. When the Node-B continuously allocates a significant amount of capacity, the RNC transmits data regardless of the allocated capacity.

The conventional flow control function can prevent a buffer overflow of the Node-B, but has a problem in that an overflow of the RNC link buffer continues because the conventional flow control function does not take into account a state of the RNC link buffer, such that link efficiency between the RNC and the Node-B becomes degraded.

### SUMMARY OF THE INVENTION

Accordingly, the present invention has been designed to solve the above and other problems occurring in the prior art. Therefore, it is an aspect of the present invention to provide a system and method for efficiently transmitting packet data between a Node-B and a radio network controller (RNC) in a mobile communication system using a high-speed downlink packet access (HSDPA) technique.

It is another aspect of the present invention to provide a system and method by which a Node-B identifies a link buffer state of a radio network controller (RNC) in a mobile communication system using a high-speed downlink packet access (HSDPA) technique.

It is another aspect of the present invention to provide a system and method by which a Node-B allocates accurate capacity by taking into account a link buffer state of a radio network controller (RNC) in a mobile communication system using a high-speed downlink packet access (HSDPA) technique.

It is yet another aspect of the present invention to provide a system and method by which a Node-B controls an amount of packet data according to a link buffer state of a radio network controller (RNC) in a mobile communication system using a high-speed downlink packet access (HSDPA) technique.

The above and other aspects of the present invention can be achieved by a system and method for performing efficient flow control between a Node-B and a radio network controller (RNC) in a mobile communication system using a high-speed downlink packet access (HSDPA) technique. The system and method comprise receiving, from the RNC, a request message for resource capacity allocation required to transmit high-speed downlink packet data in the Node-B and identifying the number of packet data units capable of being allocated by the RNC; comparing the number of packet data units requested from the RNC and the number of packet data units acceptable to the Node-B, and determining packet data for the flow control using a minimum value between the requested number of packet data units and the acceptable number of packet data units; and allocating the resource capacity according to the determined packet data, and notifying the RNC of the allocated resource capacity through a response message.

The above and other aspects of the present invention can be achieved by a system and method for controlling an amount of packet data according to a link buffer state of a radio network controller (RNC) in a Node-B provided in a mobile communication system using a high-speed downlink packet access (HSDPA) technique. The system and method comprise considering a buffer size of the Node-B and an amount of packet data requested from the RNC to determine resource capacity in the Node-B, and notifying the RNC of the determined resource capacity; counting the number of times when an amount of packet data transmitted from the RNC during a designated period is less than the determined resource capacity; and when the counted number of times is greater than the number of control flows set for total packet data transmission, allocating to the RNC less resource capacity than the determined resource capacity, and notifying the RNC of the allocated resource capacity.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates an example of a conventional high-speed downlink packet access (HSDPA) layer structure;

FIG. 2 illustrates another example of the conventional HSDPA layer structure;

FIG. 3 illustrates a flow control process and control messages in a conventional HSDPA mobile communication system;

FIG. 4 illustrates the format of a control message of a conventional high-speed downlink shared channel (HS-DSCH) CAPACITY REQUEST message;

FIG. 5 illustrates the format of a control message of a conventional HS-DSCH CAPACITY ALLOCATION message;

FIG. 6 illustrates the format of a conventional HS-DSCH data frame;

FIG. 7 illustrates a rule for transmitting a conventional HS-DSCH data frame;

FIG. 8 illustrates a flow control process in a conventional wired network;

FIG. 9 is a block diagram illustrating a Node-B and a radio network controller (RNC) for performing a flow control process in accordance with an embodiment of the present invention;

FIG. 10 is a state transition diagram illustrating a frame protocol (FP) entity of the Node-B in accordance with an embodiment of the present invention;

FIG. 11 is a flow chart illustrating a process in which an allocation mode of the Node-B is switched from a normal allocation mode to a virtual congestion allocation mode in accordance with an embodiment of the present invention; and

FIG. 12 is a flow chart illustrating a process in which the allocation mode of the Node-B is switched from the virtual congestion allocation mode to the normal allocation mode in accordance with an embodiment of the present invention.

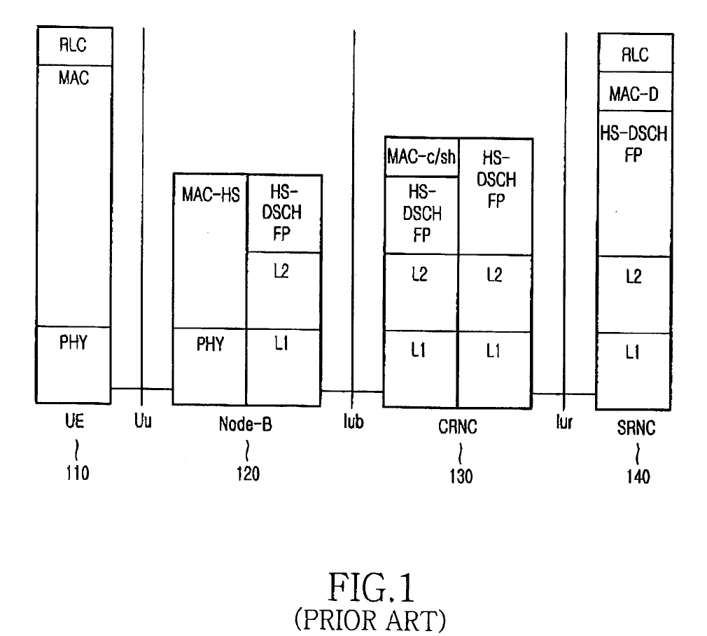

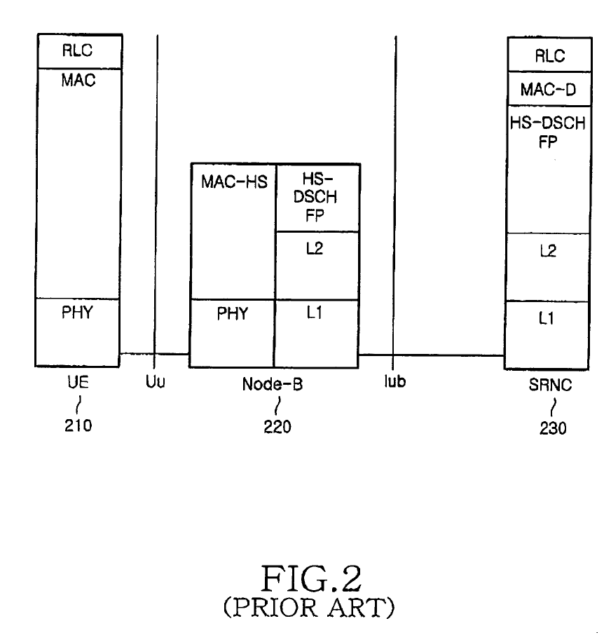

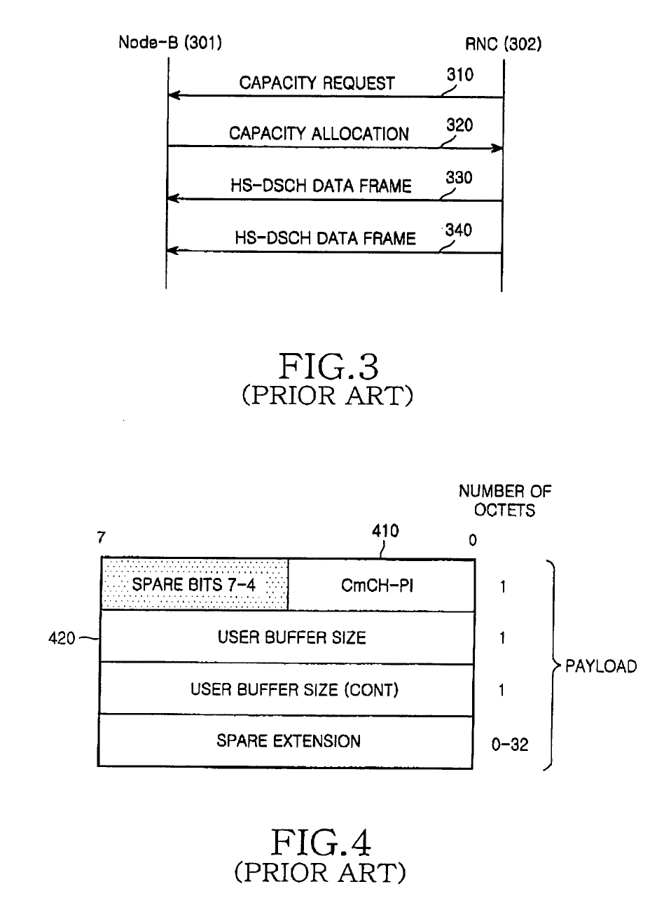

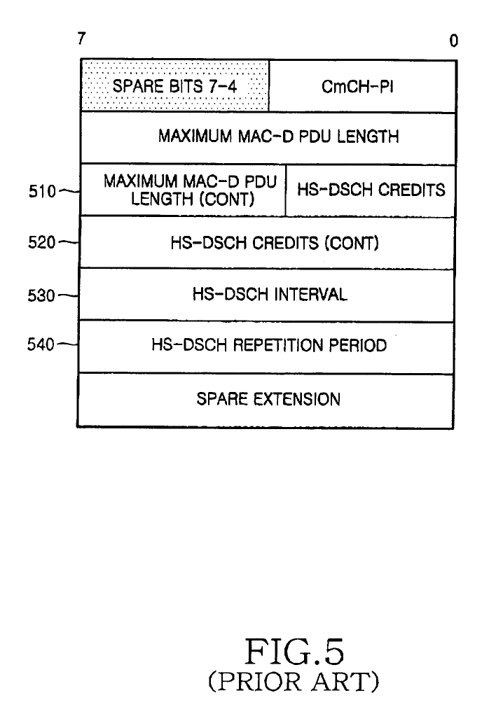

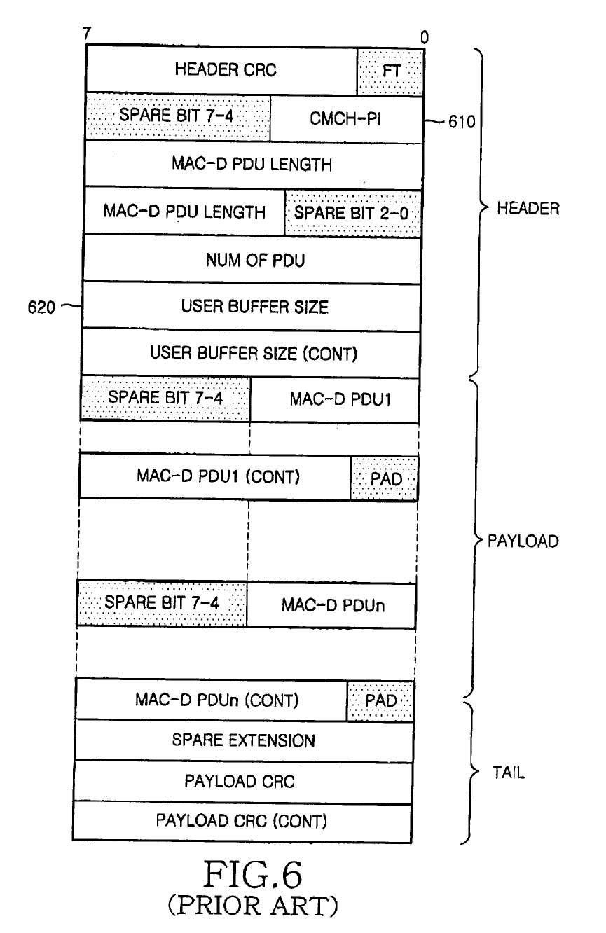

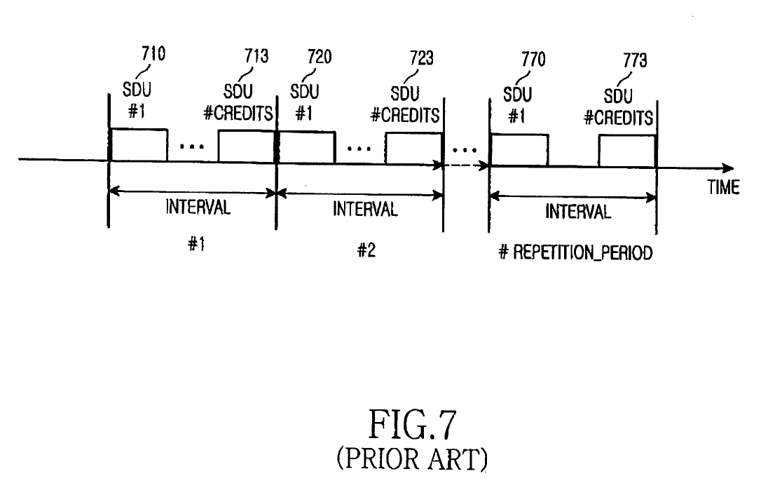

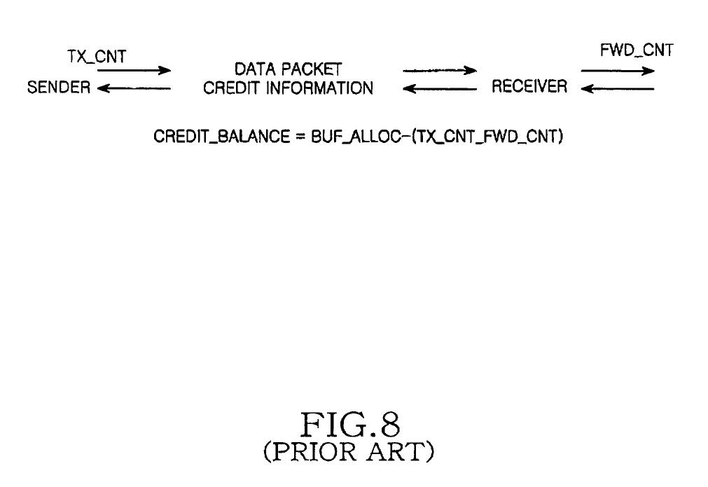

Throughout the drawings, the same element is designated by the same reference numeral or character.

### DETAILED DESCRIPTION OF EXEMPLARY EMBODIMENTS

Embodiments of the present invention will be described in detail herein below with reference to the accompanying drawings. In the following description, a detailed description of known functions and configurations incorporated herein will be omitted for conciseness. It is to be understood that the phraseology and terminology herein are exemplary and should not limit the scope of the invention.

The embodiments of the present invention provide a method for efficiently preventing a congestion state of a link buffer occurring in a high-speed downlink packet access (HSDPA) flow control process in a wideband code division multiple access (WCDMA) system defined in the 3rd Generation Partnership Project (3GPP) standard, thereby improving link efficiency. Moreover, the embodiments of the present invention provide a method for preventing the congestion state of the link buffer without requiring an additional message between a Node-B and a radio network controller (RNC).

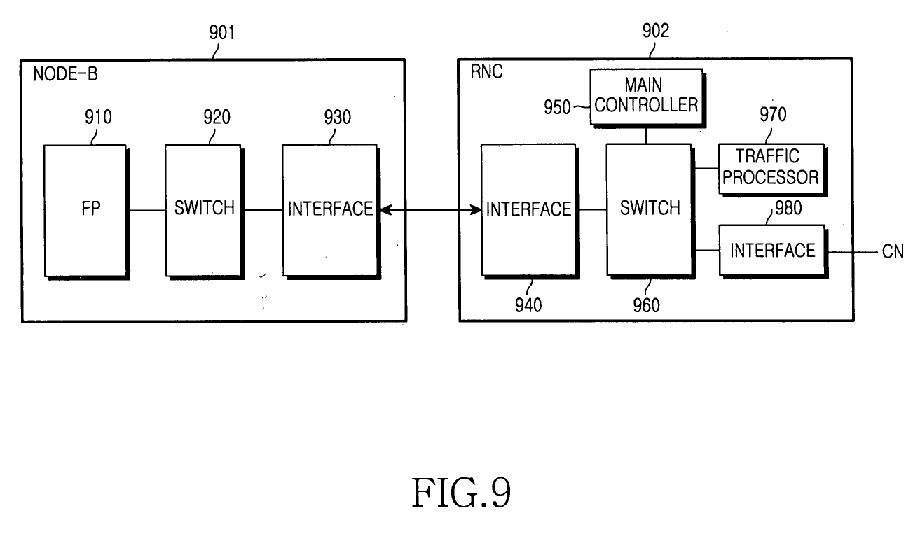

FIG. 9 is a block diagram illustrating the internal configuration of a wireless network system for performing a flow control process in accordance with an embodiment of the present invention.

Referring to FIG. 9, a radio network subsystem (RNS) includes an RNC 902 and a Node-B 901 controlled thereby in the 3G asynchronous mobile communication standard. The RNC 902 is classified as a serving RNC (SRNC), a drift RNC (DRNC), or a controlling RNC (CRNC) according to its function. The SRNC manages the High Speed Downlink Packet Access (HSDPA) service for user equipments (Ues), and serves as a RNC responsible for connection to a core network (CN). When user equipment (UE) moves to another RNC rather than the SRNC while maintaining a radio resource control (RRC) connection, the other RNC serves as the DRNC. The DRNC provides a switching/routing function between the SRNC and the UE. Meanwhile, the CRNC controls the Node-B connected to the UE for performing a communication function.

The RNC 902 serving as the SRNC and the CRNC provides the HSDPA service to the UE. A main controller 950 of the RNC 902 controls a traffic processor 970 to allocate packet data (traffic) for the UE. The packet data is received when an interface 980 supports the HSDPA service from the CN. The traffic processor 970 transfers the packet data stored according to capacity allocated from a frame protocol (FP) entity 910 of the Node-B 901 to a line interface 940 through a switch 960. The line interface 940 transfers the packet data received from the traffic processor 970 to a line interface 930 of the Node-B 901.

The FP entity 910 of the Node-B 901 determines if an amount of data received through a switch 920 and the line interface 930 of the Node-B 901 is equal to that of data of the previously allocated capacity. According to a result of the determination, the FP entity 910 allocates new resource capacity to the traffic processor 970, such that the flow of the packet data is controlled.

In accordance with an embodiment of the present invention, the FP entity 910 identifies a buffer congestion state within the line interface 940 of the RNC 902 by comparing the amount of packet data transmitted through the line interface 940 of the RNC 902 with the previously allocated resource capacity. In this case, the FP entity 910 differentiates the buffer congestion state through the normal allocation mode and the virtual congestion allocation mode to allocate different resource capacities.

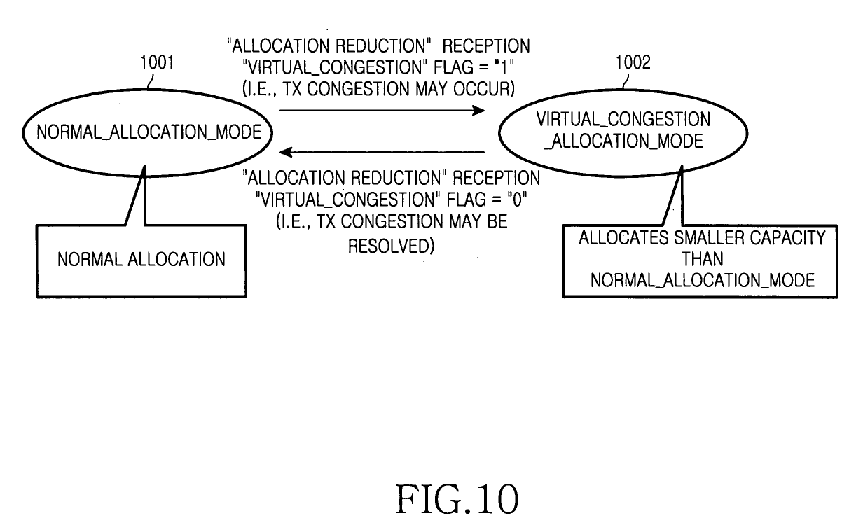

FIG. 10 is a state transition diagram illustrating the FP entity of the Node-B in accordance with an embodiment of the present invention.

Referring to FIG. 10, the FP entity of the Node-B divides the allocation mode into the normal allocation mode and the virtual congestion allocation mode.

The normal allocation mode indicates that a link buffer state of the Node-B and a link buffer state of the RNC are normal. In the normal allocation mode, resource allocation for the HSDPA is performed normally. Accordingly, the Node-B takes into account an internal reception buffer size (Rx_Buffer_Size) and an amount of data requested from the RNC through a CAPACITY REQUEST message to perform the resource allocation.

In the virtual congestion allocation mode, the Node-B takes into account congestion in an interface buffer in relation to an interface between the RNC and the Node-B, and performs resource allocation based on the congestion state. That is, the Node-B predicts congestion in the line interface of the RNC for actually transmitted packets, and allocates less capacity in the virtual congestion allocation mode than in the normal allocation mode.

As mentioned above, the Node-B determines the line interface state of the RNC. If it is determined that the line interface state of the RNC corresponds to the normal allocation mode 1001, the Node-B considers a reception buffer state of the Node-B, and sends capacity allocation information to the RNC. In this case, when information of the line interface state of the RNC indicates a virtual congestion state (Virtual_Congestion_Flag=1), the resource allocation stops. After the line interface state of the RNC is switched to the virtual congestion allocation mode 1002, the Node-B performs resource allocation based on the virtual congestion allocation mode. Less capacity is allocated in the virtual congestion allocation mode as compared with the normal allocation mode, such that the RNC load is reduced.

However, if it is determined that the line interface state of the RNC corresponds to the normal allocation mode (Virtual_Congestion_Flag=0) when a predetermined time has elapsed, the Node-B allocates resource capacity corresponding to the normal allocation mode. That is, the Node-B performs the resource allocation by considering the line interface state of the RNC, thereby efficiently transmitting packet data according to the HSDPA service.

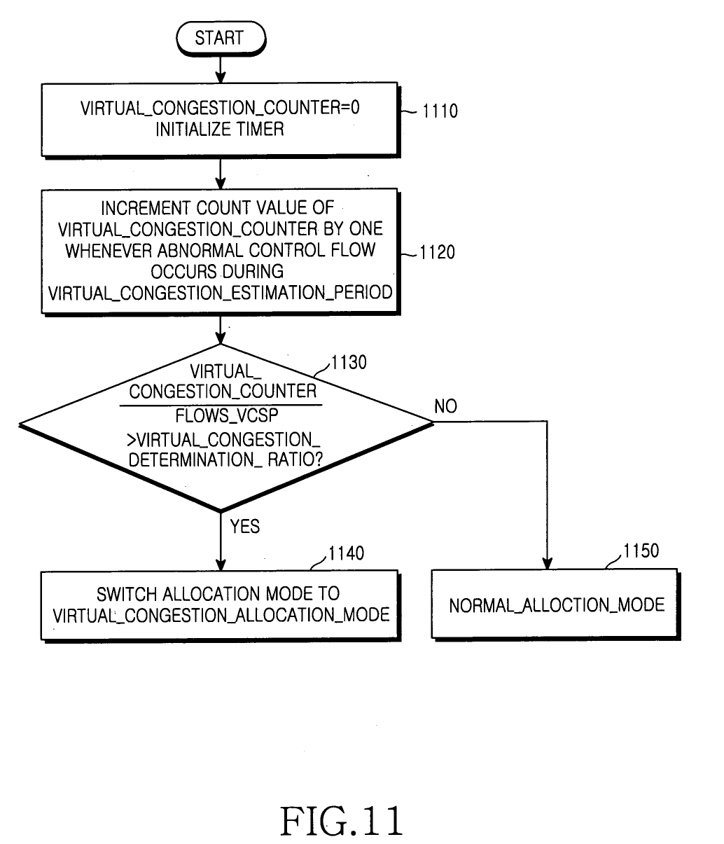

FIG. 11 is a flow chart illustrating a process in which the Node-B switches the link state of the RNC from the normal allocation mode to the virtual congestion allocation mode.

Referring to FIG. 11, the FP entity of the Node-B sets, to an initial value of 0, a virtual congestion count value (Virtual_Congestion_Counter) for identifying the line interface state of the RNC in an initial state in step 1110. The virtual congestion count value (Virtual_Congestion_Counter) is the number of abnormal control flows generated during an estimation period set to identify a congestion state of the line interface within the RNC. In step 1120, when the FP entity of the Node-B does not receive packet data based on the previous capacity allocation from the RNC, it increments the virtual congestion count value (Virtual_Congestion_Counter) by one. In step 1130, the FP entity of the Node-B determines if a ratio of the virtual congestion count value (Virtual_Congestion_Counter) to the total number of control flows (FLOWS_VCSP) measured during the estimation period (Virtual_Congestion_Estimation_Period) is greater than a reference ratio (Virtual_Congestion_Determination_Ratio). If the ratio of the virtual congestion count value (Virtual_Congestion_Counter) to the total number of control flows is greater than the reference ratio (Virtual_Congestion_Determination_Ratio), the FP entity of the Node-B proceeds to step 1140 to switch the line interface state of the RNC from the normal allocation mode to the virtual congestion allocation mode. Accordingly, the FP entity of the Node-B updates capacity allocation in the virtual congestion allocation mode or performs capacity allocation based on the congestion state for data flow associated with a new capacity allocation request in the virtual congestion allocation mode. That is, the Node-B allocates less transmission capacity in the virtual congestion allocation mode than in the normal allocation mode.

Accordingly, the FP entity of the Node-B performs resource allocation by taking into account the line interface state of the RNC, thereby reducing the RNC load.

However, if the ratio of the virtual congestion count value (Virtual_Congestion_Counter) to the total number of control flows is not greater than the reference ratio (Virtual_Congestion_Determination_Ratio) in step 1130, the FP entity of the Node-B proceeds to step 1150 to perform resource allocation based on the normal allocation mode.

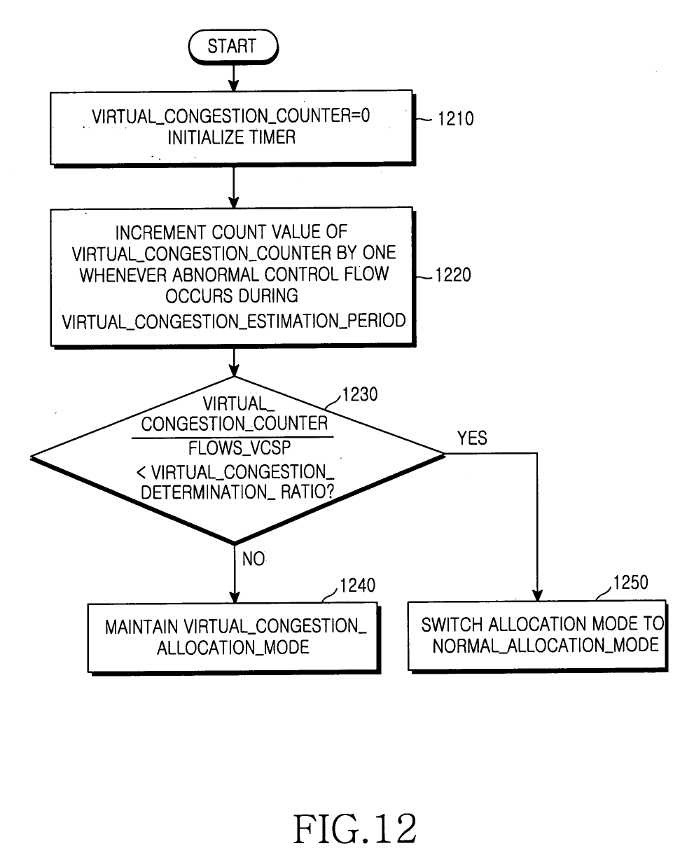

FIG. 12 is a flow chart illustrating a process in which the Node-B switches the link state of the RNC from the virtual congestion allocation mode to the normal allocation mode.

Referring to FIG. 12, the FP entity of the Node-B sets, to an initial value of 0, a virtual congestion count value (Virtual_Congestion_Counter) for identifying the line interface state of the RNC in an initial state in step 1210. The virtual congestion count value (Virtual_Congestion_Counter) is the number of abnormal control flows generated during an estimation period set to identify a congestion state of the line interface within the RNC. In step 1220, when the FP entity of the Node-B does not receive packet data based on the previous capacity allocation from the RNC, it increments the virtual congestion count value (Virtual_Congestion_Counter) by one. In step 1230, the FP entity of the Node-B determines if a ratio of the virtual congestion count value (Virtual_Congestion_Counter) to the total number of control flows (FLOWS_VCSP) measured during the estimation period (Virtual_Congestion_Estimation_Period) is less than a reference ratio (Virtual_Congestion_Determination Ratio). If the ratio of the virtual congestion count value (Virtual_Congestion_Counter) to the total number of control flows is less than the reference ratio (Virtual_Congestion_Determination_Ratio), the FP entity of the Node-B proceeds to step 1250 to switch the line interface state of the RNC from the virtual congestion allocation mode to the normal allocation mode.

However, if the ratio of the virtual congestion count value (Virtual_Congestion_Counter) to the total number of control flows is not less than the reference ratio (Virtual_Congestion_Determination_Ratio) in step 1230, the FP entity of the Node-B proceeds to step 1240 to maintain the virtual congestion allocation mode.

The resource allocation in the normal allocation mode is computed using the following Equation 1. Alternatively, the resource allocation in the normal allocation mode may be performed by means of other methods.

$$Credits = min [ \frac{{B}_{BTS , i , Threshold\_high} - {B}_{BTS , i} ( t )}{MaxPdu} , \frac{UserBufferSize}{MaxPdu} ] \\ Repetition = max [ 1 , \frac{{B}_{BTS , i , Threshold\_high} - {B}_{BTS , i} ( t )}{MaxPdu \cdot Credits} ] \\ Interval = 10 ms \cdot {N}_{load} \qquad ( 1 )$$

In the above Equation 1, “_{BBTS,i,Threshold}_{_{—}}_{high}” denotes a size of a buffer capable of storing data according to the i-th MAC-d control flow in the node-B without overflow, “B_{BTS,i}(t)” denotes an amount of buffering required for the i-th MAC-d control flow when capacity is allocated, “Credits” denotes the maximum acceptable number of packets within a range in which overflow does not occur. The minimum value between the maximum acceptable number of packets and the number of packets requested from the RNC is set as a value of “Credits”. In the above Equation 1, “Interval” is basically set to a multiple of 10 ms, and is accurately set in proportion to a system load N_{load}, and “Repetition” denotes a repetition period, and is set to 1 when the number of packets requested from the RNC is greater than the number of packets acceptable to the Node-B.

The resource allocation in the virtual congestion allocation mode is computed using the following Equation 2. Alternatively, the resource allocation in the virtual congestion allocation mode may be performed by means of other methods.

$$\begin{matrix}Credits = min [ \frac{{B}_{BTS , i , Threshold\_high} - {B}_{BTS , i} ( t )}{MaxPdu} , \frac{UserBufferSize}{MaxPdu} ] \cdot \\ Allocation\_Ratio \_Virtual {\_Congestion}_{K} \\ Repetition = max [ 1 , \frac{{B}_{BTS , i , Threshold\_high} - {B}_{BTS , i} ( t )}{MaxPdu \cdot Credits} ] \\ Interval = 10 ms \cdot {N}_{load}\end{matrix} \qquad ( 2 )$$

In terms of resource capacity allocation, HS-DSCH credits in the normal allocation mode are similar to those in the virtual congestion allocation mode. Only, when a ratio (Allocation_Ratio_Virtual_Congestion_{K}) according to the congestion state is taken into account, allocation capacity in the virtual congestion allocation mode is smaller than that in the normal allocation mode. The ratio (Allocation_Ratio_Virtual_Congestion_{K}) according to the congestion state is used to ensure credits according to a priority K of a user as in the normal allocation mode.

Because a control message is sent only when new resource capacity is allocated, the total system load does not increase.

As described above, the embodiments of the present invention have a number of advantageous effects.

For example, an embodiment of the present invention provides a basic technique capable of performing normal flow control according to the 3GPP standard. More specifically, the embodiment of the present invention can prevent abnormal flow control by performing a flow control process by considering a buffer state of the RNC line interface.

Because the flow control process is performed by considering a congestion state of the RNC line interface, the efficiency of using a line interface between the RNC and the Node-B improves.

Although embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

1. A method for performing efficient flow control between a Node-B and a radio network controller (RNC) in a mobile communication system using a high-speed downlink packet access (HSDPA), comprising:
receiving, from the RNC, a request message for resource capacity allocation required to transmit high-speed downlink packet data in the Node-B and identifying the number of packet data units capable of being allocated by the RNC;
comparing the number of packet data units requested from the RNC and the number of packet data units acceptable to the Node-B, and determining packet data for the flow control using a minimum value between the requested number of packet data units and the acceptable number of packet data units; and
allocating the resource capacity according to the determined packet data, and notifying the RNC of the allocated resource capacity through a response message.

2. The method according to claim 1, wherein the Node-B depending at least in part on the priorities of user equipments (UEs) supporting the high-speed downlink packet data, allocates the resource capacity and performs the flow control.

3. A method for controlling an amount of packet data according to a link buffer state of a radio network controller (RNC) in a Node-B provided in a mobile communication system using a high-speed downlink packet access (HSDPA), comprising:
considering a buffer size of the Node-B and an amount of packet data requested from the RNC to determine resource capacity in the Node-B, and notifying the RNC of the determined resource capacity;
counting the number of times when an amount of packet data transmitted from the RNC during a designated period is less than the determined resource capacity; and
when the counted number of times is greater than the number of control flows set for total packet data transmission, allocating to the RNC less resource capacity than the determined resource capacity, and notifying the RNC of the allocated resource capacity.

4. The method according to claim 3, wherein the Node-B determines , as the resource capacity, an amount of packet data corresponding to a minimum value between a value of the buffer size of the Node-B and a value of the amount of packet data requested from the RNC, and notifies the RNC of the determined packet data amount.

5. The method according to claim 4, wherein when the counted number of times is greater than the number of control flows set for the total packet data transmission, the Node-B switches a state of the RNC from normal allocation mode to virtual congestion allocation mode, allocates less resource capacity than the previously determined resource capacity, and notifies the RNC of the allocated resource capacity through a control message.

6. The method according to claim 5, further comprising:
differentiating the flow control for the total packet data transmission according to the counted number of times in the normal allocation mode and the virtual congestion allocation mode, and allocating the resource capacity of the RNC.

7. A system comprising a Node-B and a radio network controller (RNC) for performing efficient flow control in a mobile communication system using a high-speed downlink packet access (HSDPA), comprising:
the RNC being adapted to transmit a request message for resource capacity allocation for transmitting high-speed downlink packet data and identifying the number of packet data units capable of being allocated by the RNC;
the Node-B being adapted to compare the number of packet data units requested from the RNC and the number of packet data units acceptable to the Node-B, and determine packet data for the flow control using a minimum value between the requested number of packet data units and the acceptable number of packet data units, allocate the resource capacity according to the determined packet data and notify the RNC of the allocated resource capacity through a response message.

8. The system according to claim 7, wherein the Node-B allocates the resource capacity and performs the flow control, depending at least in part on the priorities of user equipments (UEs) supporting the high-speed downlink packet data.

9. A system for controlling an amount of packet data according to a link buffer state of a radio network controller (RNC) in a Node-B provided in a mobile communication system using a high-speed downlink packet access (HSDPA), comprising:
the Node-B being adapted to consider a buffer size of the Node-B and an amount of packet data requested from the RNC to determine resource capacity in the Node-B, and notify the RNC of the determined resource capacity, count the number of times when an amount of packet data transmitted from the RNC during a designated period is less than the determined resource capacity, when the counted number of times is greater than the number of control flows set for total packet data transmission, allocate to the RNC less resource capacity than the determined resource capacity, and notify the RNC of the allocated resource capacity.

10. The system according to claim 9, wherein the Node-B determines , as the resource capacity, an amount of packet data corresponding to a minimum value between a value of the buffer size of the Node-B and a value of the amount of packet data requested from the RNC, and notifies the RNC of the determined packet data amount.

11. The system according to claim 10, wherein when the counted number of times is greater than the number of control flows set for the total packet data transmission, the Node-B switches a state of the RNC from normal allocation mode to virtual congestion allocation mode, allocates less resource capacity than the previously determined resource capacity, and notifies the RNC of the allocated resource capacity through a control message.

12. The system according to claim 11, the Node-B is further adapted to differentiate the flow control for the total packet data transmission according to the counted number of times in the normal allocation mode and the virtual congestion allocation mode, and allocate the resource capacity of the RNC.
